(19) United States
(12) Patent Application Publication
(10) Pub. No.: US 2009/0021957 A1
(43) Pub. Date: Jan. 22, 2009

(54) Table lamp structure

(76) Inventor: Chia-Yeh Wu, Hsinchu City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/878,003

(22) Filed: Jul. 20, 2007

(51) Int. Cl. F21V 8/00; F21V 7/00

(52) U.S. Cl. 362/555

(57) ABSTRACT

The present invention discloses an improved table lamp, which comprises: a lamp base, an arm and a lamp hood. The lamp hood has a light-emitting element. The light-emitting element includes: a light conduction tube, a light conduction material and at least one light-emitting diode. A reflective mirror is arranged on the inner face of the lamp hood and around the light-emitting element. When the light-emitting diode emits light, the light-emitting element also emits light via the conduction of the light conduction tube and the reflection of the light conduction material. Then, the light emitted by the light-emitting element is reflected out by the reflective mirror. Thereby, the present invention can increase the illumination area, promote the brightness, decrease the number of required LEDs and reduce the cost.

### BACKGROUND OF THE INVENTION

1. Field of the Invention

The present invention relates to an improved table lamp structure, particularly to a LED table lamp structure.

2. Description of the Related Art

Recently, many nations have confronted power shortage and the greenhouse effect. However, LED has the characteristics of long service life, low power consumption, low heat generation, high color purity, high vibration-resistance, high toughness, high compactness and no pollution. Therefore, LED has gradually been used in illumination for saving energy. Under an identical illumination, LED can save about 40% energy in comparison with an incandescent lamp. Thus, LED can effectively decrease power consumption and reduce the usage of fossil fuels. Therefore, LED can obviously decrease CO₂ emission and greatly contribute to the solution of the greenhouse effect and environmental problems.

A Taiwan patent No. M279798 disclosed an “Improved Structure of a LED Illumination Light Source”, wherein the light conduction tube is fabricated with an extrusion or injection method, and the light reflection plate is integrated with the light conduction tube with a printing plus adhesion method; alternatively, the light conduction tube and the light reflection plate are fabricated into a one-piece part. After the original shape has been formed with the extrusion or injection method, the combination of the light conduction tube together with the light reflection plate can be further fabricated into another shape. The light conduction tube and the light reflection plate create the reflected light—the primary light source, and the scattered light—the secondary light source. The illumination range can be varied via modifying the length and width of the light reflection plate. The “Improved Structure of a LED Illumination Light Source” is to solve the problems of incandescent lamps or fluorescent lamps. However, LED has the disadvantages of low luminous flux and low optical efficiency. Therefore, the conventional illumination light source needs a lot of LEDs to obtain sufficient brightness, and the cost thereof is thus increased.

Accordingly, the present invention proposes an improved table lamp structure to overcome the abovementioned problems.

### SUMMARY OF THE INVENTION

The primary objective of the present invention is to provide an improved table lamp structure, wherein a light conduction material is coated on the interior of a light conduction tube to increase illumination area and promote brightness.

Another objective of the present invention is to provide an improved table lamp structure, wherein LED (Light-Emitting Diode) replaces the traditional electric bulb to reduce power consumption, decrease the number of lamp replacement and promote economic efficiency.

Further another objective of the present invention is to provide an improved table lamp structure, wherein a light conduction material is used to reflect the light effectively, thus the number of the required LEDs is decreased, and the cost is reduced.

To achieve the abovementioned objectives, the present invention proposes an improved table lamp structure, which comprises: a lamp base, an arm extending upward from the lamp base, and a lamp hood fixed to the arm. The lamp hood has a light-emitting element which includes a light conduction tube. When the light-emitting diodes on at least one end of the light conduction tube emit light, the light-emitting element also emits light via the conduction of the light conduction tube and the reflection of a light conduction material which coated on one lateral side of the interior of the light conduction tube. Further, the light emitted by the light-emitting element is reflected out by a reflective mirror arranged on the inner face of the lamp hood and around the light-emitting element.

Below, the embodiments are described in detail in cooperation with the attached drawings to make easily understood the objectives, technical contents, characteristics and accomplishments of the present invention.

### BRIEF DESCRIPTION OF THE DRAWINGS

FIG. 1 is a diagram schematically showing an improved table lamp structure according to the present invention;

FIG. 2 is a diagram schematically showing the reflection in light projection of an improved table lamp structure according to the present invention;

FIG. 3 is a sectional view schematically showing a light-emitting element of an improved table lamp structure according to the present invention; and

FIG. 4 is an exploded view schematically showing a light-emitting element of an improved table lamp structure according to the present invention.

### DETAILED DESCRIPTION OF THE INVENTION

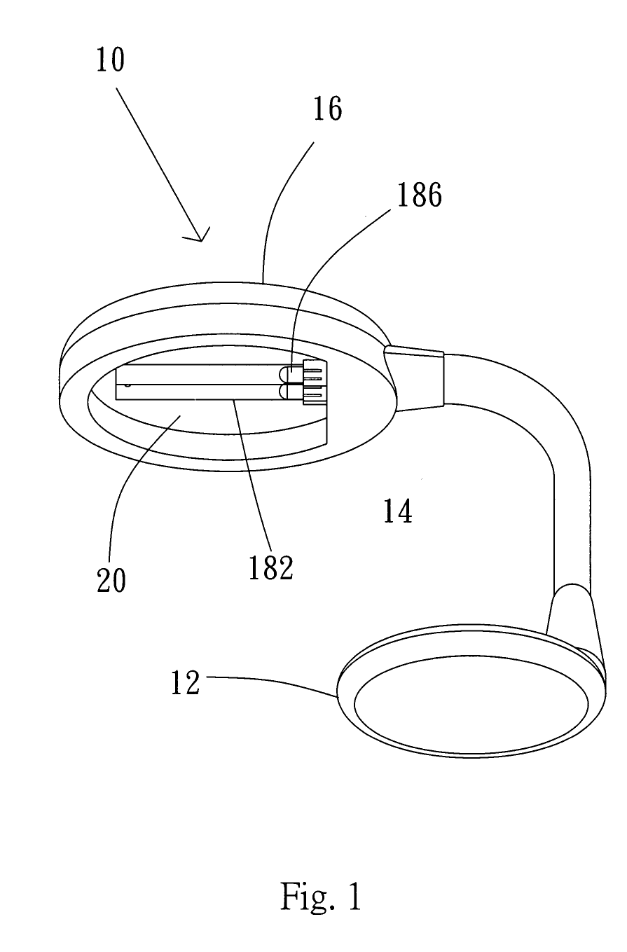

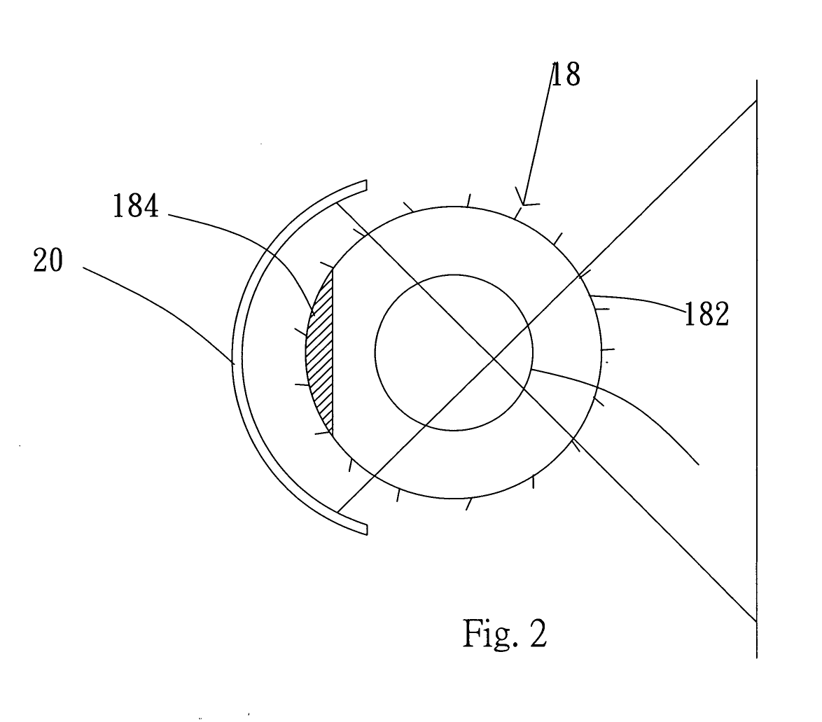

Refer to FIG. 1 and FIG. 2 diagrams respectively schematically showing an improved table lamp structure and the reflection in light projection according to the present invention. The improved table lamp structure of the present invention comprises: a lamp base 12, an arm 14 coupled to the lamp base 12 and extending upward from the lamp base 12, and a lamp hood 16 fixed to the arm 14. The lamp hood 16 has a light-emitting element 18 thereinside. The light-emitting element 18 includes a light conduction tube 182. A light conduction material 184 is coated on one lateral side of the interior of the light conduction tube 182. Light-emitting diodes (LED) 186 and 186′ are respectively arranged on both sides of the light conduction tube 182. A reflective mirror 20 is arranged on the inner face of the lamp hood 16 and around the light-emitting element 18. When the light-emitting diodes 186 and 186′ emit light, the light-emitting element 18 also emits light via the conduction of the light conduction tube 182 and the reflection of the light conduction material 184. Then, the light emitted by the light-emitting element 18 is reflected out by the reflective mirror 20. Thereby, the illumination area is enlarged, and the brightness is promoted.

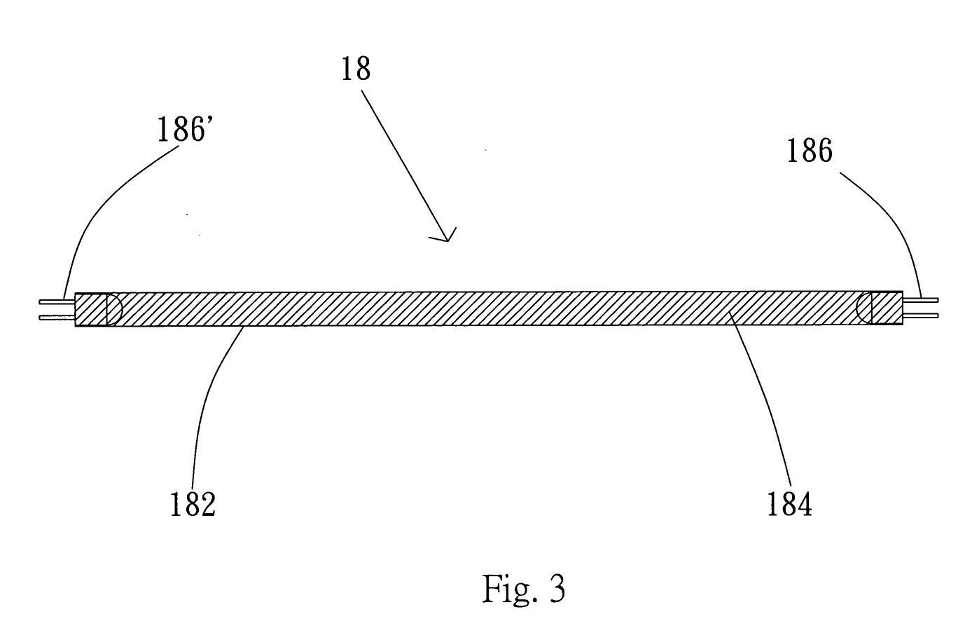

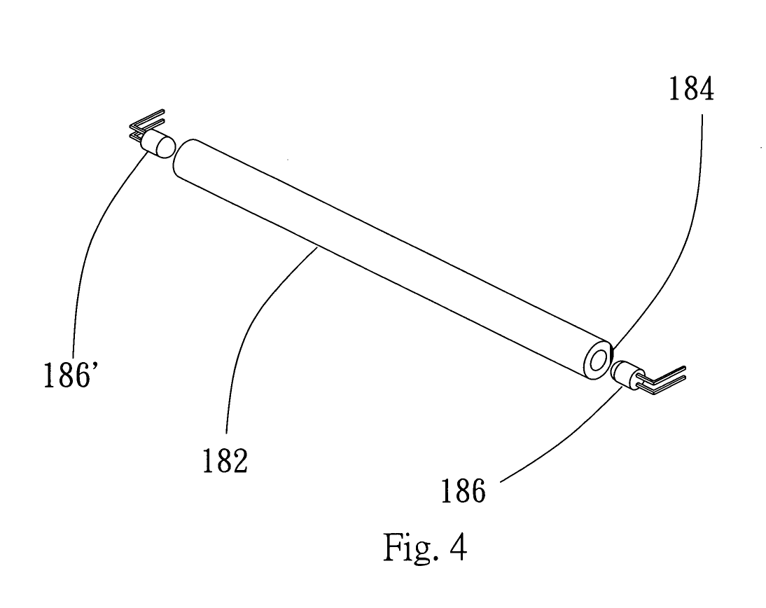

Refer to FIG. 3 and FIG. 4 a sectional view and an exploded view schematically showing a light-emitting element of an improved table lamp structure according to the present invention. The light-emitting element 18 includes the light conduction tube 182, which is made of a thermolplastic or a flexible plastic. In the embodiment shown in the drawings, the light conduction tube 182 is fabricated into a strip-like shape. However, due to the thermoplasticity or flexibility, the shape of the light conduction tube 182 may be varied according to users' requirements. The light conduction material 184 may be an inorganic light conduction material and is coated on one lateral side of the interior of the light conduction tube 182. When the light-emitting diodes 186 and 186′ on both sides of the light conduction tube 182 are turned on to emit light, the light-emitting element 18 also emits light via the conduction of the light conduction tube 182 and the reflection of the light conduction material 184. Further, the light emitted by the light-emitting element 18 is concentrated and reflected out by the reflective mirror. The light-emitting diodes 186 and 186′ may be installed onto the light conduction tube 182 via an inlay method or an adhesion method. The light-emitting diodes 186 and 186′ may be SMD (Surface Mount Device) LEDs, polycrystalline LEDs or high power LEDs.

In conclusion, the present invention proposes an improved table lamp structure, wherein LED, which consumes less power and has a longer service life, replaces the traditional electric bulb to reduce power consumption, decrease the number of lamp replacement and promote economic efficiency. Further, a light conduction material is coated on one lateral side of the interior of the light conduction tube to reflect the light effectively. Thus it can help the light-emitting element increase the illumination region and promote the brightness. Thereby, the present invention can decrease the number of required LEDs, reduce the cost and promote the economic efficiency.

The embodiments described above are only to demonstrate the technical thoughts and characteristics of the present invention to enable the persons skilled in the art to understand, make, and use the present invention. However, it is not intended to limit the scope of the present invention. Any equivalent modification or variation according to the spirit of the present invention is to be also included within the scope of the present invention.

What is claimed is:

1. An improved table lamp structure comprising:
a lamp base;
an arm coupled to said lamp base and extending upward from said lamp base;
a lamp hood fixed to said arm; and
a light-emitting element arranged in said lamp hood and having a light conduction tube, wherein a light conduction material is coated on one internal lateral side of said light conduction tube; at least one end of said light conduction tube has a light-emitting diode; when said light-emitting diode emits light, said light-emitting element also emits light via conduction of said light conduction tube and reflection of said light conduction material.

2. An improved table lamp structure according to claim 1, wherein a reflective mirror is arranged on an inner face of said lamp hood and around said light-emitting element to reflect out light emitted by said light-emitting element.

3. An improved table lamp structure according to claim 1, wherein said light-emitting diode is installed onto said light conduction tube via an inlay method.

4. An improved table lamp structure according to claim 1, wherein said light-emitting diode is installed onto said light conduction tube via an adhesion method.

5. An improved table lamp structure according to claim 1, wherein said light-emitting diode (LED) is an SMD (Surface Mount Device) LED, a polycrystalline LED or a high power LED.

6. An improved table lamp structure according to claim 5, wherein said light conduction material is an inorganic light conduction material.

7. An improved table lamp structure according to claim 1, wherein said light conduction tube is in a form of a strip.

8. An improved table lamp structure according to claim 1, wherein said light conduction tube is made of a thermoplastic or a flexible plastic.
